(19) United States
(12) Patent Application Publication
(10) Pub. No.: US 2007/0055617 A1
(43) Pub. Date: Mar. 8, 2007

(54) Method and apparatus for creating a benefit plan

(76) Inventors: Frederick Garcia, Huntington Beach, CA (US); Brenda Garcia, Huntington Beach, CA (US); Rico Garcia, Huntington Beach, CA (US); Ronald Truss, Highland, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/218,752

(22) Filed: Sep. 2, 2005

(51) Int. Cl. G06Q 40/00

(52) U.S. Cl. 705/38

(57) ABSTRACT

A benefit plan for a member of a Native American Indian tribe comprises providing a life insurance policy to be owned by the member and having provisions for a death benefit and a cash surrender value. A premium payment for the life insurance policy is received, wherein at least a portion of the premium payment is obtained from loan proceeds generated by a loan from the Native American Indian tribe to the member. At least a portion of the loan proceeds is money that otherwise would be paid by the Native American Indian tribe to the member as unearned income. The loan is secured by a security interest provided by the member to the Native American Indian tribe in at least a portion of at least one of the death benefit and cash surrender value of the life insurance policy.

### 1. FIELD OF INVENTION

This relates in general to a method and apparatus for creating a benefit plan. More particularly, this relates to a method and apparatus for creating a plan for a Native American Indian tribal member that is funded by money paid by the tribe.

### 2. BACKGROUND

Native American Indian tribes are treated differently from non-governmental entities. That treatment stems from the unique legal status of Indian tribes and the federal government's stated policy of respecting tribal self-determination, territorial integrity, and economic development. (See, e.g., Indian Reorganization Act, 25 U.S.C. §461 et seq., the Indian Gaming Regulatory Act, 25 U.S.C. §2701 et seq.) Included in this unique status is the authorization for some tribes to conduct gaming operations. For some tribes, these gaming operations result in profits that are distributed to the tribal members as “per capita” payments.

The nature of the relationship between a tribe and its members is unusual. The tribal member's income from per capita payments is considered to be “unearned” as that term is used within the meaning of the federal tax code. That is, a per capita payment is not the result of any job, wage or similar compensation arrangement, but rather, is a payment issued by a tribal government to an individual member as part of a government program.

For some tribes, the per capita distributions from gaming are high at this point in time. However, these high levels of distributions are not guaranteed to last. Thus it would be desirable to have a savings mechanism whereby a portion of these distributions can be saved and invested on a tax-deferred basis, so that if the current per capita distributions decrease, tribal members will still have financial resources. Commonly-known, tax-deferred retirement plans include 401(k) and IRA plans. However, tribal members are not able to use income (e.g. salary) based.

What is needed therefore is an improved, long-term financial security mechanism for per capita income that grows in value on a tax-deferred basis.

### SUMMARY OF THE ILLUSTRATED EMBODIMENTS

Methods and apparatuses for creating a benefit plan for a member of a Native American Indian tribe are provided.

In one aspect, a method is performed at least in part within a computer device and comprises providing a life insurance policy to be owned by the member and having provisions for a death benefit and a cash surrender value. A premium payment for the life insurance policy is received, wherein at least a portion of the premium payment is obtained from loan proceeds generated by a loan from the Native American Indian tribe to the member. At least a portion of the loan proceeds is money that otherwise would be paid by the Native American Indian tribe to the member as unearned income. The loan is secured by a security interest provided by the member to the Native American Indian tribe in at least a portion of at least one of the death benefit and cash surrender value of the life insurance policy.

In another aspect the life insurance policy is issued by an insurance provider and the premium payment is sent to the insurance provider by the Native American Indian tribe.

In yet another aspect, the at least a portion of the death benefit is about equal to the amount of the loan.

In another aspect, the life insurance policy is a variable universal life policy.

In yet another aspect, the loan is due for repayment on the earlier of a predetermined time period or the death of the member.

In another aspect, the loan is repayable with interest at a below-market interest rate.

In yet another aspect, the unearned income is at least a portion of a per capita payment generated from gaming business operations of the Native American Indian tribe.

In another aspect, a Tribal resolution is issued wherein the Native American Indian tribe agrees to undertake obligations and to waive its sovereign immunity from suit to allow for enforcement of the obligations. The obligations include providing the loan to the member and reporting the loan to the Internal Revenue Service.

There are additional aspects to the present inventions. It should therefore be understood that the preceding is merely a brief summary of some embodiments and aspects of the present inventions. Additional embodiments and aspects of the present inventions are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of the preferred embodiments, taken in conjunction with the accompanying drawings of which:

FIG. 1 is a simplified hardware system diagram showing a computer environment in accordance with an embodiment of the present invention;

FIG. 2 is a simplified illustration of a per capita payment and related tax effects;

FIG. 3 is a simplified illustration of contractual arrangements between a tribe, a tribal member and an insurance provider in accordance with an embodiment of the invention;

FIG. 4 is a simplified illustration showing the flow of funds between various entities at the beginning and end of a time period in accordance with an embodiment of the invention;

FIG. 5 is an illustration chart of an exemplary build-up of a death benefit and cash surrender value in a life insurance policy over time in accordance with an embodiment of the invention; and

FIG. 6 is a flow chart diagram of a benefit plan in accordance with an embodiment of the invention.

### DETAILED DESCRIPTION

Reference will now be made in detail to embodiments of the present invention, examples of which are illustrated in the accompanying drawings, wherein like reference numerals refer to like elements throughout. It is understood that other embodiments may be utilized and structural and operational changes may be made without departing from the scope of the present invention.

Disclosed is a tax-deferred benefit plan involving the use of a split-dollar life insurance and loan arrangement. According to one embodiment of the invention, the arrangement is created between a Native American Indian tribe and an individual tribal member, utilizing a loan agreement, promissory notes, a collateral assignment agreement, and an insurance policy. The arrangement is between the tribe, a quasi-sovereign governmental entity, and one of the tribe's members. It is, in essence, a governmental program designed to enhance the long term financial security of a tribal citizen and his/her family.

In general, a split-dollar life insurance arrangement is an arrangement between two or more parties to allocate the policy benefits and, in some cases, the costs of a life insurance contract. Internal Revenue Service (“IRS”) regulations generally define a split-dollar life insurance arrangement more narrowly to be any arrangement between an owner of a life insurance contract and a non-owner of the contract under which either party to the arrangement pays all or part of the premiums, and one of the parties paying the premiums is entitled to recover (either conditionally or unconditionally) all or any portion of those premiums and such recovery is to be made from, or is secured by, the proceeds of the contract. The IRS definition does not cover the purchase of an insurance contract in which the only parties to the arrangement are the policy owner and the life insurance company acting only in its capacity as issuer of the contract.

According to one embodiment of the invention, a split-dollar life insurance arrangement is employed whereby the tribe uses a portion of what otherwise would be the member's unearned income payable by the tribe as an interest-free loan extended to the member in order to pay the premiums on a life insurance policy. The revenue for the unearned income is generated from business operations of the tribe, such as gaming, lumber, oil, mining, tourism, etc. The policy provides the tribal member's beneficiaries or estate with substantial death benefits. A portion of the premium payment is placed in an investment portfolio within the life insurance plan whereby the portfolio is chosen by the tribal member. As the portfolio value grows, the cash surrender value and the death benefit of the life insurance policy will grow. The life insurance policy is a variable universal life policy, although in other embodiments other policies, such as universal life policies or whole life policies could be used as well.

The reduction in the tribal member's unearned income payment (such as for example, a per capita payment), meanwhile, will reduce the member's taxable income and, therefore, reduce his/her current-year tax liability. At the end of the loan period, the tribal member will repay the loan via insurance policy proceeds.

The benefits of the split-dollar life insurance arrangement to the tribal member may include: financial security for the beneficiaries of the life insurance policy, long term investment growth on pre-tax money, and reduced tax liability during the period of the loan.

The benefits of this method are also significant from the point of view of the tribe since it has a continuing concern about the long-term welfare of the members of the tribe. The split-dollar life insurance method described here may help to ensure that, years from now, tribal members and their families will have a dependable source of income other than tribal unearned income (e.g., per capita) payments. This requires relatively few demands on tribal government personnel and resources. The tribe is responsible for accounting for the loans, the reporting to the IRS of the income from the transaction (e.g., the imputed interest on the loan), withholding taxes, etc. The tribe incurs no significant or large new costs, because the money to be used for the method is from funds that would otherwise be distributed to members as unearned income payments from funds that are generated by the business operations of the tribe.

A component of this arrangement is that it meet the requirements of Section 7872 of the Internal Revenue Code (26 U.S.C. §7872) and the regulations that have been enacted to implement that section (26 CFR § 1.6, 26 CFR §1.7872-15). It is in this respect that certain embodiments of the invention are unique, since to the inventors' knowledge, no other similar arrangement for an Indian tribe and their members is known to meet the requirements of the federal regulations relating to split-dollar life insurance arrangements.

According to one embodiment of the invention, a tribal member enters into a split-dollar loan agreement with a tribe. The loan agreement requires the tribe to provide the member with annual, no interest, loans to be used exclusively for the payment of annual premiums on a life insurance policy for the member, as the owner of the policy. Along with the loan agreement, the member and the tribe enter into two related agreements: a promissory note and a collateral assignment agreement.

The agreements prohibit the member from using any money loaned to him or her under the agreements for any purpose other than the funding of the life insurance policy. To ensure that the loans are used exclusively for the payment of the insurance premiums, the loans are issued in the form of premium payments made directly from the tribe to the insurance provider. The agreements require the repayment of the loan/premium payments by the member, and the repayment of the loan is fully recourse to the member. The repayment is effected by the insurance policy which provides for payment of at least a portion of the cash surrender value and death benefit directly from the insurance company to the tribe.

At the outset, the tribe's Tribal Council enacts a Resolution stating that the tribe wishes to carry out the transaction, including a waiver of the tribe's sovereign immunity for the purposes of enforcement of the provisions of the agreement. The tribe acts as the initiating party and therefore is responsible for all tax withholding, reporting, and record keeping of any monies loaned to the member, including the identification and accounting of each premium as a separate loan, the reporting of imputed interest, and the creation and delivery of IRS Forms 1099 to the member.

A percentage of what otherwise would be the member's present per capita (or other unearned income) payment is used to fund the payment of the premiums on a life insurance policy through loans to the member. It is believed that this arrangement qualifies as a split-dollar life insurance arrangement as defined in 26 CFR §1.61. Under this arrangement the tribe makes the loans interest free, and therefore, the payment of the premiums using the money loaned by the tribe is believed to qualify as below market split-dollar loans under 26 CFR §1.7872-15 and 26 U.S.C. §7872. Those provisions require that the member pay income tax only on the imputed interest on the loan, using the calculation method set forth in 26 U.S.C. §7872 and 26 CFR §1.7872-15, based on the rates set forth in 26 U.S.C. §1274.

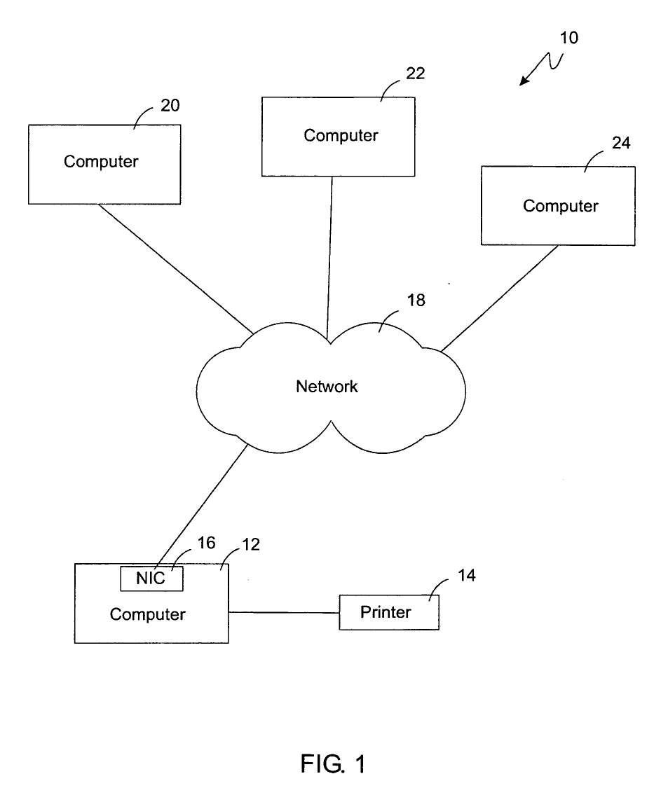

FIG. 1 is a simplified hardware system diagram showing a computer environment in accordance with an embodiment of the present invention. In a computer system 10, a computer 12, which may be a personal computer, is connected to a printer 14. The computer 12 is used for entering actuarial data associated with an applicant to a benefit plan. The computer 12 is also coupled via a computer-to-computer communication device, such as, for example, a network interface card 16, to a network 18, in this case the Internet, for communications with a plurality of computer systems 20, 22, 24 used by one or more insurance carriers, insurance brokers, benefit plan representatives, tribal representatives, tribal members, etc.

The printer 14 is used to print out benefit plan examples and descriptions of insurance policy benefits, as well as the plan agreements. The computer system 10 may be used by a benefit plan representative, a tribal representative or an insurance broker to generate plan presentations and plan agreement contracts, policies, and other plan documents in accordance with the present invention. The computer system 10 may also be used by a tribal member who is looking on the Internet or elsewhere for information about the plan, for investment options, and who is conducting email or other electronic communications with representatives of the other parties to the plan.

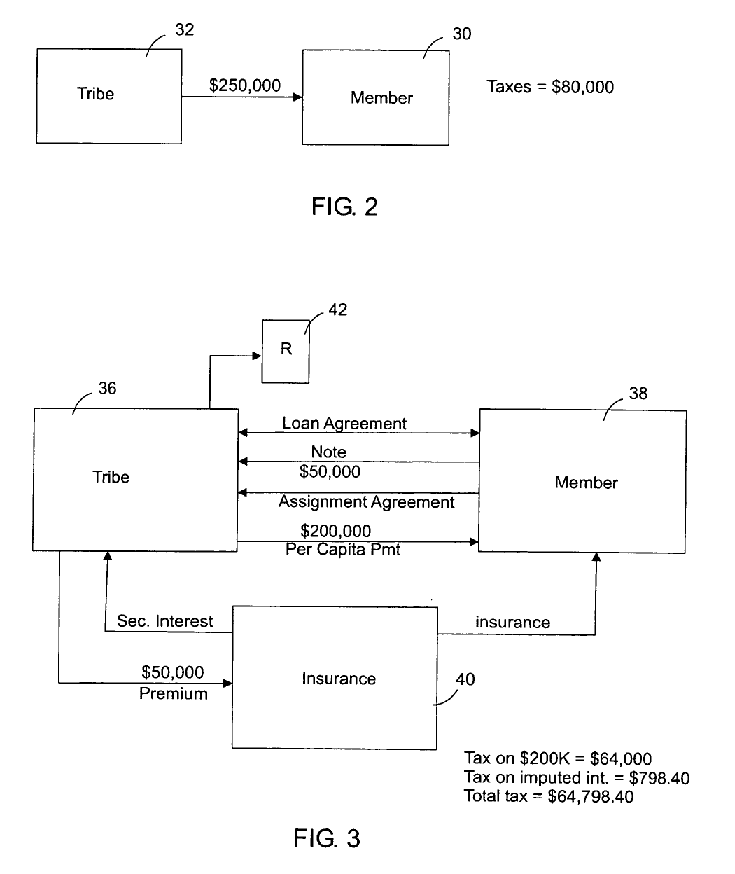

FIG. 2 illustrates an example of a per capita payment and related tax effects when embodiments of the invention are not used. In a given year, a tribal member 30 in this example receives a per capita payment of $250,000 from his/her tribe 32 as a result of gamin activity profits. Assuming this member 30 is in the 32% tax bracket and that this is the only income received for the year, then it is believed that federal taxes in the amount of about $80,000 would be owed to the IRS under current regulations.

FIG. 3 illustrates the contractual arrangements between a tribe 36, a tribal member 38 and an insurance company 40 or other insurance provider along with the tax savings in accordance with an embodiment of the invention. The tribe 36 passes a Tribal Resolution 42 agreeing to enter into this transaction and waiving its sovereign immunity from suit for purposes of enforcement of the agreements associated with the arrangement.

The tribe 36 and the member 38 execute benefit plan documents comprising a loan agreement, a note and an assignment agreement. The insurance company 40 issues a life insurance policy to be owned by the member 38. The policy has both a death benefit and a cash surrender value, portions of each of which are allocated to both the member 38 and the tribe 36. Rather than pay a $250,000 per capita payment as shown in FIG. 2, the tribe 36 pays a per capita payment of $200,000 to the member 38 as directed by the member 38 pursuant to these benefit plan documents.

The member 38 signs a promissory note for an interest-free loan and thereby borrows the difference, or $50,000, from the tribe 36. The loan is a term loan, ie., for a predetermined time period, such as for example 20 years, but is payable not later than on or about the date of death of the member 38. To secure repayment to the tribe 36 of the interest-free loan, the member 38 also executes the assignment agreement assigning to the tribe 36 a security interest in the member's 38 right to receive the at least a portion of cash surrender value and death benefit from the insurance policy. The tribe 36 pays the $50,000 loan proceeds directly to the insurance company as an annual policy premium.

Under current IRS regulations and prevailing interest rates, the annual imputed interest on the $50,000 interest-free loan is believed to be about $2,495.00 which would be imputed income to the member 38 for tax purposes. Therefore by using the arrangement of FIG. 3, it is believed that the member 38 would owe current year federal taxes of about $64,000 on the $200,000 per capita distribution plus an additional amount of about $798.40 federal taxes on the imputed interest as calculated pursuant to IRS regulations on the interest-free loan received from the tribe 36. As can be seen this total of $64,798.40 federal taxes is substantially less than the taxes owed in the example of FIG. 2.

In alternative embodiments, the loan from the tribe 36 could be other than an interest-free loan. For example the loan could require the payment of interest at below-market rates within the meaning of IRS regulations which nevertheless would still result in federal tax liability for an imputed interest amount. In another example, the loan interest could be at rates that are not below-market (within the meaning of IRS regulations) in which event there would be no federal tax liability for an imputed interest amount.

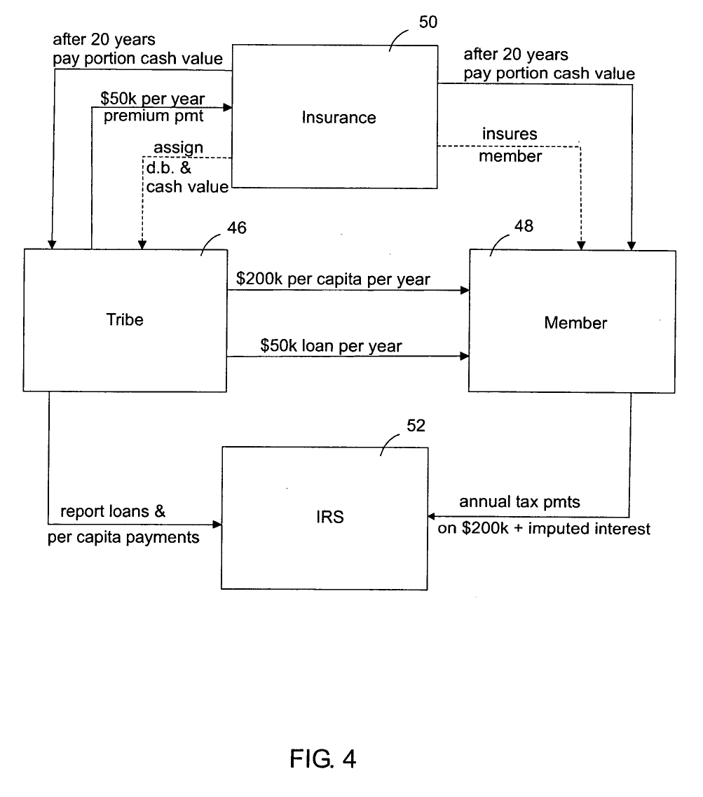

FIG. 4 is a simplified diagram showing the flow of funds between various entities at the beginning and the end of a time period during which an insurance policy is in force according to an embodiment of the invention. There is shown a tribe 46, a tribal member 48, an insurance provider 50, and the IRS 52.

During the first year, the tribe 46 makes a per capita payment in the amount of $200,000 to the member 48. Additionally, the tribe 46 makes an interest-free loan in the amount of $50,000 to the member 48. However, pursuant to a loan agreement, the loan proceeds are paid directly from the tribe 46 to the insurance provider 50 to be used as an annual policy premium on a life insurance policy owned by the member 48, but at least a portion of the cash value and death benefits of which are assigned to the tribe 46 as collateral for the loan. At the end of this first year, the tribe 46 reports the per capita payment of $200,000 and the interest free loan to the IRS 52. Also, the member 48 pays taxes to the IRS 52 based on income corresponding to the per capita payment plus the imputed interest relating to the interest free nature of the loan.

Each year, a new promissory note in the amount of the annual policy premium is executed by the member 48, a new assignment agreement is executed, and the above-described pattern of payments is repeated. Each annual payment is considered a new loan and is accounted for and reported to the IRS 52 by the tribe 46 as a new loan. However the payments do not have to be the same each year. The member 48 elects from year to year how much of an annual policy premium is to be paid, and the tribe 46 extends a loan to the member 48 in the amount of the elected annual policy premium and makes a per capita payment to the member 48 equal to an amount of money that the member 48 otherwise would have received less the loan amount. Also during these years, the member 48 provides instructions to the insurance provider 50 as to how the policy fuids are to be invested. Thus variations in the policy premiums paid and the rate of return on the investments selected by the member 48 will affect both the death benefit and cash surrender value of the insurance policy.

Still referring to FIG. 4, at the end of the loan term (or when the member 48 desires to terminate the policy if prior to the loan term), say after 20 years, for example, the cumulative debt associated with the plurality of annual loans becomes due. At this point, the insurance provider 50 pays at least a portion of the cash surrender value of the policy directly to the tribe 46. The amount paid to the tribe 46 is equal to the total of the annual loans that the tribe 46 made to the member 48 for premium payments. Additionally, the insurance provider 50 pays any balance of the cash surrender value of the policy directly to the member 48.

After the loan is repaid, the tribe 46 places this money in the tribe's treasury and may use the funds in any manner that the tribe 46 sees fit. The tribe 46 has the discretion to use the money to provide funding for essential governmental programs and services to its members, including per capita or other payments, and is obligated to meet the requirements of any provisions of the Internal Revenue Code and the regulations promulgated pursuant thereto that apply to such use. Therefore in deciding whether to participate in this benefit plan, the member 48 should weigh the foregoing flow of fuids, etc. against the advantages of the plan, including the death benefit features, investment returns and current-year tax deferrals.

In formulating a benefit plan, a plan sponsor selects an insurance company or insurance provider whose products are intended to be used in conjunction with the benefit plan. Software provided by the selected insurance company is used for computations. The insurance company software, after considering the inputted premium data and actuarial data, renders a death benefit amount and cash surrender value for funding the benefit plan contemplated for the tribal member. A policy software illustration and an actual policy based on the inputted data are printed out on the printer 14 (FIG. 1).

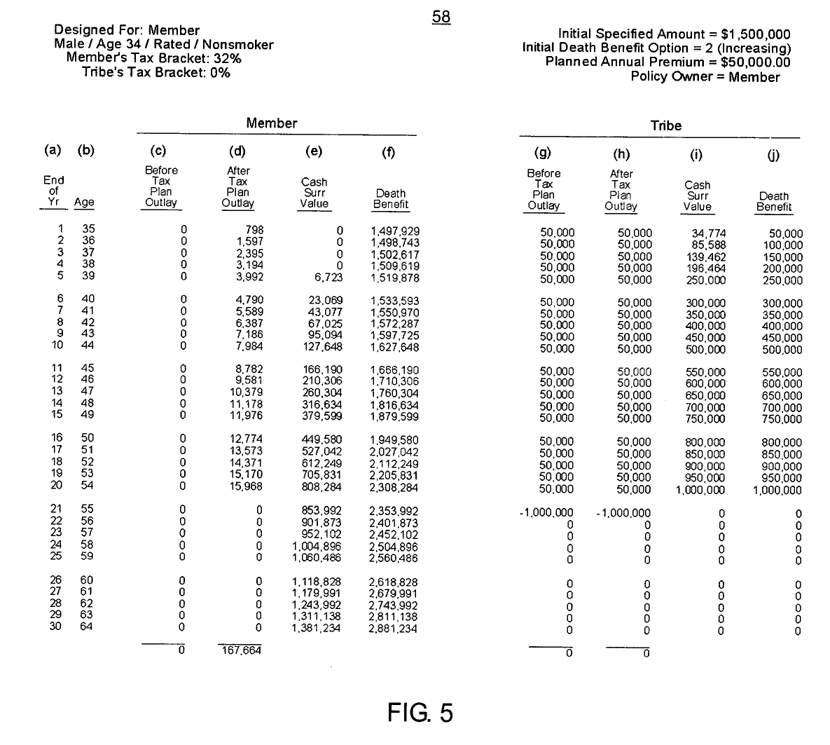

FIG. 5 is an illustration chart 58 of an exemplary build-up of a death benefit and a cash surrender value over time in a variable universal life insurance policy in accordance with an embodiment of the invention. The death benefit and cash surrender value are allocated between a tribal member and a Native American Indian tribe. The dollar amounts in FIG. 5 assume a policy owner who is a 34 year old male tribal member in a 32% tax bracket who does not smoke and who is planning on paying annual premiums of $50,000 for 20 years. This will yield a $1,500,000 life insurance policy with a build up of a death benefit and cash surrender value over time as shown. This illustration further assumes that during the time period shown, the member directed the investments of the policy finds such that an average annual return on the investments was 8%.

Column (d), the after tax plan outlay, represents the income taxes owed each year by the member for the imputed interest on the $50,000 annual interest-free loans extended by the tribe. In other words, column (d) represents the extra taxes owed by the member each year due to his or her participation in the benefit plan. This amount of the after tax plan outlay increases each year as a result of the increase in the interest-free, cumulative debt owed to the tribe as a result of executing a new promissory note each year in the amount of that year's annual policy premium.

Columns (e) and (f) represent the cash surrender value and death benefit value payable directly to the member from the insurance company. Columns (g) and (h) represent the annual policy premiums paid to the insurance company by the tribe as a result of the loan agreement between the tribe and the member. Because Native American Indian tribes are not required to pay federal income taxes, a 0% tax bracket is used for the calculations and figures in columns (g) and (h).

Columns (i) and (j) represent the cash surrender value and the death benefit value payable to the tribe by the insurance company for the policy year in question. Thus columns (i) and (j) represent the capacity for repayment of the premium loans that were extended to the member by the tribe. Note that the policy is structured so that the death benefit payable to the tribe is equal to the total debt owed by the member for the policy premiums. Thus should the member die at any point in time while the debt is outstanding, the tribe will be repaid in full from the policy.

At the end of 20 years the cash surrender value shown in column (i) is $1,000,000 which equals the total of the annual premiums paid for this time period and the total debt owed by the member to the tribe. Because the loans are structured to terminate after 20 years in this example, the insurance company would pay the $1,000,000 cash surrender value directly to the tribe to discharge this debt. The member will receive the amount in column (e), or $808,284, representing the portion of the cash surrender value that the policy pays directly to the member. Alternatively however, the member could elect to not receive the amount in column (e) at that point in time. Rather he could elect to allow the cash surrender value and death benefit to continue to grow as a result of the investments within the policy, without the need for further policy premium payments.

As seen in column (j), the split-dollar life policy is structured so that should the member die at any time during the first 20 years of the plan, the death benefit payable to the tribe equals the total amount of the loans extended by the tribe to the member for premium payments. This death benefit was assigned as collateral for the loans, and therefore, should the member die at any point in time during the first 20 years, the death benefit is paid by the insurance company to the tribe and will extinguish the loan obligation of the member's estate.

Note that in this example, any termination of the policy by the member on or after 5 years will result in full repayment to the tribe of the policy premiums (i.e. the debt) paid from the cash surrender value as shown in column (i). However, should the member terminate the policy prior to the end of the 5^{th} year, then its cash surrender value shown in column (i) is less than the total of the policy premiums paid. Accordingly, the member would have an outstanding loan obligation for the difference to the tribe pursuant to the terms of the loan.

For example, if the member desired to terminate the policy at the end of year two, loans from the tribe for the premiums would total $100,000. However, the cash surrender value paid to the tribe would be $85,588. While the insurance company would pay this sum to the tribe to be treated as partial repayment of the member's loan obligation, the difference, or $14,412, still would be owed by the member to the tribe. It therefore usually is not desirable for a member to terminate a policy too early in the plan period.

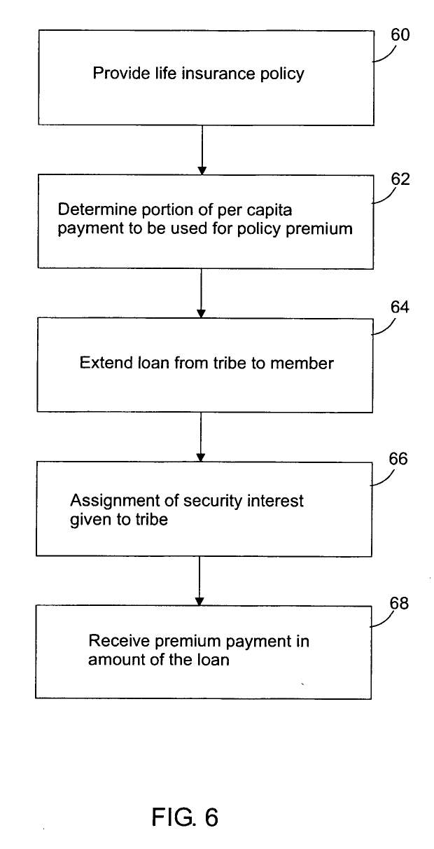

FIG. 6 is a flow chart diagram of an embodiment of the present invention that is performed at least in part within a computer. A life insurance policy to be owned by a member of a Native American Indian tribe and having provisions for a death benefit and a cash surrender value is provided. 60 The member determines the portion of what otherwise would be his or her full per capita payment that is to be used for the annual policy premium for that year. 62 A loan is extended from the Native American Indian tribe to the member to generate loan proceeds. 64 The loan is secured by an assignment from the member to the tribe of a security interest in at least a portion of both the death benefit and cash surrender value of the life insurance policy. 66 A premium payment for the life insurance policy is received by the insurance provider wherein at least a portion of the premium payment is obtained from the loan proceeds. 68

Some of the steps described above in connection with FIGS. 3-6 may be performed by a plan representative, insurance agent, or plan provider prior to the time in which a specific tribal member who is applying for a plan requests a policy. For example, a table of data (generated, for example, by policy software using the computer system 10 of FIG. 1) may be produced ahead of time showing costs, premiums, etc. for many different potential tribal member plan applicants and policy details and benefits.

Embodiments of the present invention may be implemented, in whole or in part, with any combination of hardware and software. It is to be understood that while various communications taking place between various computers may be conveniently accomplished via electronic mail, other forms of communication may also be employed, such as, for example, postal mail, telephone or other forms of communication. Also, the policy benefit calculations, such as those of the type shown in FIG. 5, may be accomplished by the insurance company computer, the plan representative computer, or by any other computer.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A method for creating a benefit plan for a member of a Native American Indian tribe, comprising:
providing a life insurance policy to be owned by the member and having provisions for a death benefit and a cash surrender value; and
receiving a premium payment for the life insurance policy,
wherein at least a portion of the premium payment is obtained from loan proceeds generated by a first loan from the Native American Indian tribe to the member,
wherein at least a portion of the loan proceeds is money that otherwise would be paid by the Native American Indian tribe to the member as unearned income, and
wherein at least one of the foregoing steps is performed at least in part within a computer device.

2. The method of claim 1 wherein the first loan is secured by a security interest provided by the member to the Native American Indian tribe.

3. The method of claim 2 wherein the security interest is for at least a portion of at least one of the death benefit and cash surrender value of the life insurance policy.

4. The method of claim 1 wherein the life insurance policy is issued by an insurance provider and wherein the premium payment is sent to the insurance provider by the Native American Indian tribe.

5. The method of claim 1 wherein the at least a portion of the death benefit is about equal to the amount of the first loan.

6. The method of claim 1 wherein the life insurance policy is a variable universal life policy.

7. The method of claim 1 wherein the first loan is due for repayment on the earlier of one of a predetermined time period and the death of the member.

8. The method of claim 1 wherein the first loan is repayable with interest at a below-market interest rate.

9. The method of claim 1 wherein the first loan is an interest-free loan.

10. The method of claim 1 wherein the unearned income is at least a portion of a payment generated from business operations of the Native American Indian tribe.

11. The method of claim 10 wherein the payment is a per capita payment.

12. The method of claim 11 wherein the business operations are gaming operations.

13. The method of claim 1 further comprising issuing a Tribal resolution wherein the Native American Indian tribe agrees to undertake obligations and to waive a sovereign immunity from suit to allow for enforcement of the obligations, wherein the obligations include providing the first loan to the member and reporting the first loan to the Internal Revenue Service.

14. The method of claim 1 further comprising receiving a plurality of additional premium payments for the life insurance policy,
wherein at least a portion of each of the plurality of additional premium payments is obtained from additional loan proceeds generated by a plurality of additional loans from the Native American Indian tribe to the member, and
wherein at least a portion of the additional loan proceeds is money that otherwise would be paid by the Native American Indian tribe to the member as unearned income.

15. The method of claim 14 wherein the plurality of additional loans is secured by a plurality of additional security interests provided by the member to the Native American Indian tribe.

16. The method of claim 15 wherein each of the plurality of additional security interests is for at least a portion of at least one of the death benefit and cash surrender value of the life insurance policy.

17. The method of claim 14 wherein each of the plurality of additional premium payments is an annual premium payment.

18. The method of claim 14 wherein each of the plurality of additional loans is an interest-free loan.

19. The method of claim 14 wherein each of the plurality of additional loans is a new loan.

20. The method of claim 14 wherein the plurality of additional loans is evidenced by a plurality of promissory notes, and wherein each of the plurality of promissory notes is executed by the member at about the time of receipt of each of the plurality of additional premium payments.

21. The method of claim 14 wherein the at least a portion of the death benefit is about equal to a debt represented by the first loan plus the plurality of additional loans.

22. A method for creating a benefit plan for a member of a Native American Indian tribe, comprising:
providing a life insurance policy to be owned by the member and having provisions for a death benefit and a cash surrender value; and
receiving a premium payment for the life insurance policy,
wherein at least a portion of the premium payment is obtained from loan proceeds generated by a loan from the Native American Indian tribe to the member,
wherein at least a portion of the loan proceeds is money that otherwise would be paid by the Native American Indian tribe to the member as unearned income,
wherein the loan is secured by a security interest provided by the member to the Native American Indian tribe in at least a portion of at least one of the death benefit and cash surrender value of the life insurance policy,
wherein the life insurance policy is issued by an insurance provider and wherein the premium payment is sent to the insurance provider by the Native American Indian tribe,
wherein the loan is due for repayment on the earlier of one of a predetermined time period and the death of the member, and
wherein at least one of the foregoing steps is performed at least in part within a computer device.

23. The method of claim 22 wherein the at least a portion of the death benefit is about equal to the amount of the loan.

24. The method of claim 22 wherein the life insurance policy is a variable universal life policy.

25. The method of claim 22 wherein the loan is repayable with interest at a below-market interest rate.

26. The method of claim 22 wherein the unearned income is at least a portion of a per capita payment generated from gaming business operations of the Native American Indian tribe.

27. A method for creating a benefit plan for a member of a Native American Indian tribe, comprising:
providing a life insurance policy to be owned by the member and having provisions for a death benefit and a cash surrender value, wherein the life insurance policy is issued by an insurance provider;
providing a loan from the Native American Indian tribe to the member thereby generating loan proceeds, wherein the loan is due for repayment on the earlier of one of a predetermined time period and the death of the member;
sending a premium payment for the life insurance policy to the insurance provider, wherein the premium payment is sent to the insurance provider by the Native American Indian tribe, wherein at least a portion of the premium payment is obtained from the loan proceeds, and wherein at least a portion of the loan proceeds is money that otherwise would be paid by the Native American Indian tribe to the member as unearned income; and
providing the Native American Indian tribe with a security interest in at least a portion of at least one of the death benefit and cash surrender value of the life insurance policy,
wherein at least one of the foregoing steps is performed at least in part within a computer device.

28. The method of claim 27 wherein the at least a portion of the death benefit is about equal to the amount of the loan.

29. The method of claim 27 wherein the life insurance policy is a variable universal life policy.

30. The method of claim 27 wherein the loan is repayable with interest at a below-market interest rate.

31. The method of claim 27 wherein the unearned income is at least a portion of a per capita payment generated from gaming business operations of the Native American Indian tribe.

32. A method for creating a benefit plan for a member of a Native American Indian tribe, comprising:
providing a variable universal life insurance policy to be owned by the member and having provisions for a death benefit and a cash surrender value; and
receiving a premium payment for the life insurance policy,
wherein at least a portion of the premium payment is obtained from loan proceeds generated by a loan from the Native American Indian tribe to the member,
wherein at least a portion of the loan proceeds is money that otherwise would be paid by the Native American Indian tribe to the member as at least a portion of a per capita payment generated from gaming business operations of the Native American Indian tribe,
wherein the loan is secured by a security interest provided by the member to the Native American Indian tribe in at least a portion of at least one of the death benefit and cash surrender value of the life insurance policy,
wherein the life insurance policy is issued by an insurance provider and wherein the premium payment is sent to the insurance provider by the Native American Indian tribe,
wherein the loan is due for repayment on the earlier of one of a predetermined time period and the death of the member, and
wherein at least one of the foregoing steps is performed at least in part within a computer device.

33. The method of claim 32 wherein the at least a portion of the death benefit is about equal to the amount of the loan.

34. The method of claim 32 wherein the loan is repayable with interest at a below-market interest rate.

35. An apparatus for creating a benefit plan for a member of a Native American Indian tribe, comprising:
means for providing a life insurance policy to be owned by the member and having provisions for a death benefit and a cash surrender value; and
means for receiving a premium payment for the life insurance policy,
wherein at least a portion of the premium payment is obtained from loan proceeds generated by a loan from the Native American Indian tribe to the member,
wherein at least a portion of the loan proceeds is money that otherwise would be paid by the Native American Indian tribe to the member as unearned income,
wherein the loan is secured by a security interest provided by the member to the Native American Indian tribe in at least a portion of at least one of the death benefit and cash surrender value of the life insurance policy,
wherein the life insurance policy is issued by an insurance provider and wherein the premium payment is sent to the insurance provider by the Native American Indian tribe,
wherein the loan is due for repayment on the earlier of one of a predetermined time period and the death of the member, and
wherein at least one of the means comprises a computer device.
